(19) United States
(12) Patent Application Publication
(10) Pub. No.: US 2015/0169710 A1
(43) Pub. Date: Jun. 18, 2015

(54) METHOD AND APPARATUS FOR PROVIDING SEARCH RESULTS

(71) Applicant: Beijing Baidu Netcom Science and Technology Co., Ltd., Beijing (CN)

(72) Inventors: Yongming XU, Beijing (CN); Na ZHANG, Beijing (CN); Jia LU, Beijing (CN); Ying XU, Beijing (CN); Hui XU, Beijing (CN); Ruiyang WANG, Beijing (CN); Jingjing SUN, Beijing (CN); Fengle ZHOU, Beijing (CN); Lei XU, Beijing (CN); Yingjuan SONG, Beijing (CN)

(21) Appl. No.: 14/573,452

(22) Filed: Dec. 17, 2014

(30) Foreign Application Priority Data
Dec. 18, 2013 (CN) 201310700811.8

(51) Int. Cl. G06F 17/30

(52) U.S. Cl. CPC G06F 17/30554; G06F 17/30705

(57) ABSTRACT

The present invention provides a method and apparatus for providing search results, wherein the method comprises: obtaining a plurality of search results corresponding to a query request, wherein the plurality of search results comprise one or more search result classifications, each search result classification corresponds to one or more tags; determining presentation pattern information corresponding to the search result classification based on the one or more tags corresponding to the search result classification; providing at least one of the search result classifications to the corresponding user according to the corresponding presentation pattern information. The present invention helps the user to quickly find the desired information when the user's search demand is indefinite.

### FIELD OF THE INVENTION

The present invention relates to an Internet technology, and more specifically to a method and apparatus for providing search results.

### BACKGROUND OF THE INVENTION

Obtaining desired information through searching the Internet has currently become one of major approaches for a user to obtain information. However, the intention or demand of the user for information search is not always clear and definite. When the user's intention or demand is not clear and definite, the query words provided by the user always cannot explicitly embody the user's query demand. In this case, the prior art only provides to the user a plurality of search results obtained according to the query words provided by the user in a manner of list in a webpage, and the user needs to click onto the plurality of search results one by one to browse the contents of the plurality of search results one by one, so as to determine which search result is actually desired by him/her. Such method of providing search results to a user in the prior art causes a poor search experience to the user because when the user's search demand is not explicit, the speed for the user to obtain the desired information is relatively slow. Particular, currently, it is quite prevalent for a user to use a mobile terminal to perform information search. Since a screen of a mobile terminal is relatively small, the prior art method of providing searches to a user is not intuitive, and the user operation is not convenient.

### SUMMARY OF THE INVENTION

A technical problem being solved by the present invention is providing a method and apparatus for providing search results, to solve the problem that the prior art manner of providing search results to a user causes the speed for the user to obtain the desired information to be relatively slow when the user's search demands are not definite.

According to one aspect of the present invention, there is provided a method for providing search results, comprising

obtaining a plurality of search results corresponding to a query request, wherein the plurality of search results comprise one or more search result classifications, each search result classification corresponds to one or more tags;

determining presentation pattern information corresponding to the search result classification based on the one or more tags corresponding to the search result classification;

providing at least one of the search result classifications to the corresponding user according to the corresponding presentation pattern information.

According to another aspect of the present invention, there is further provided an apparatus for providing a search result, comprising:

a search result obtaining module configured to obtain a plurality of search results corresponding to a query request, wherein the plurality of search results comprise one or more search result classifications, each search result classification corresponds to one or more tags;

a presentation pattern information determining module configured to determine presentation pattern information corresponding to the search result classification based on the one or more tags corresponding to the search result classification;

a presentation pattern information providing module configured to provide at least one of the search result classifications to the corresponding user according to the corresponding presentation pattern information.

Compared with the prior art, the present invention has the following advantages: by classifying the search results according to tabs and providing the search result classifications to the user according to the presentation pattern information corresponding to the respective tags, when the user's search demand is not explicit, the present information facilitates the user to quickly find the desired information.

### BRIEF DESCRIPTION OF THE DRAWINGS

Other features, objectives and advantages of the present invention will become more apparent through reading the detailed description of the non-limiting embodiments with reference to the accompanying drawings:

FIG. 1 shows a flow diagram of a method for providing search results according to one embodiment of the present invention;

FIG. 2 shows a schematic diagram of presentation pattern information corresponding to the search result classifications in the method of the present invention;

FIG. 3 shows a schematic diagram of an apparatus for providing search results according to one embodiment of the present invention.

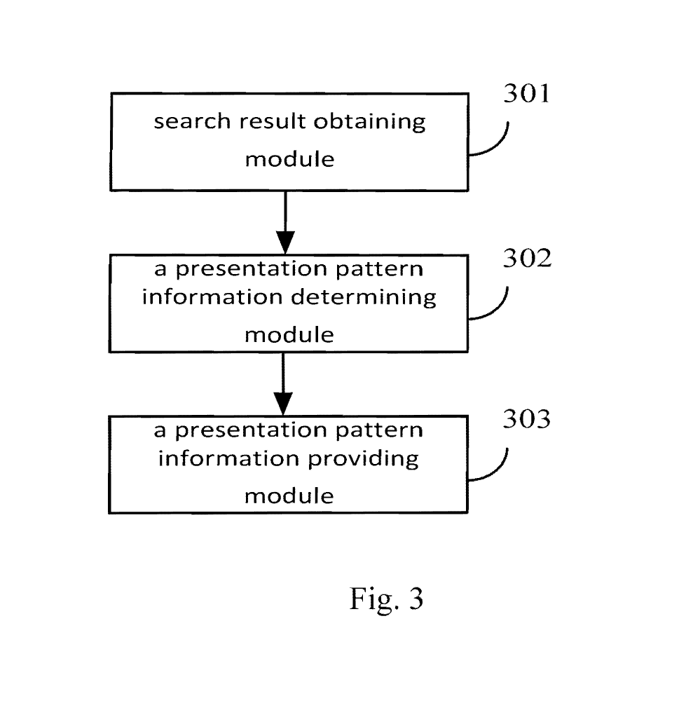

In the accompanying drawings, the same or similar reference numerals represent the same or similar components.

### DETAILED DESCRIPTION OF THE PREFERRED EMBODIMENTS

Hereinafter, the present invention will be described in further detail with reference to the accompanying drawings.

In the present invention, a network device comprises an electronic device capable of automatically performing numerical calculation and information processing according to pre-set or pre-stored instructions, whose hardware includes, but not limited to a microprocessor, an application-specific integrated circuit (ASIC), a field programmable gate array (FPGA), a digital processor (DSP), an embedded device, and the like. The network device includes, but not limited to, a computer, a network host, a single network server, a plurality of network server clusters, or a cloud composed of a plurality of servers; here, the cloud is composed of a great number of computers or network servers based on cloud computing, wherein cloud computing is a kind of distributed computation, or a virtual super computer composed of a group of loosely coupled computer clusters. The user equipment includes, but not limited to, any mobile electronic product performing human-machine interaction with a user through a keyboard, a touch pad, or a voice control device, e.g., a smart phone, a PDA (personal digital assistant). The network includes, but not limited to, Internet, wide area network, metropolitan area network, local area network, VPN network, Ad Hoc network, and etc. those skilled in the art should understand that other user equipments, network devices, and networks, if applicable to the present invention, should also be included within the protection scope of the present invention and are incorporated here by reference.

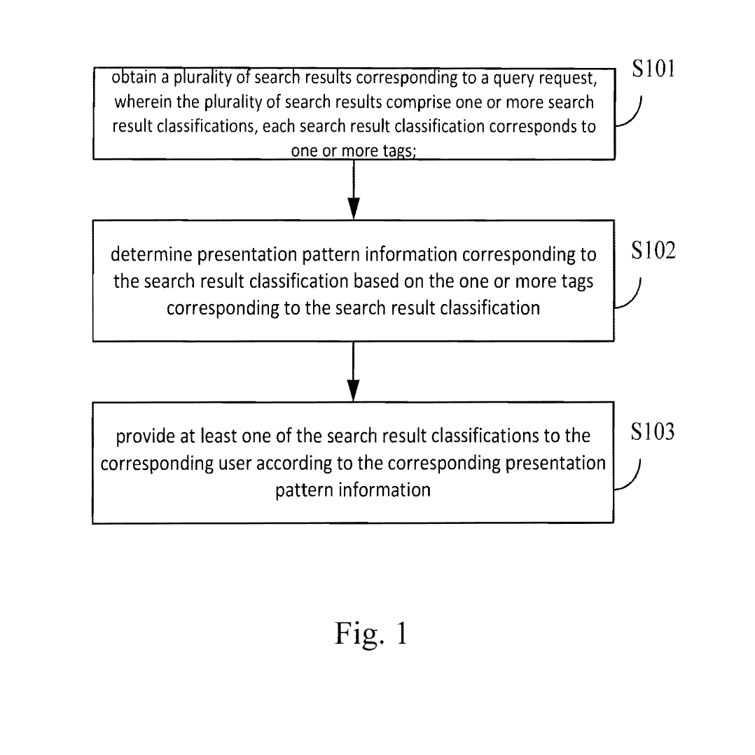

FIG. 1 shows a flow diagram of a method for providing search results according to one embodiment of the present invention.

As shown by FIG. 1, at step S101, the network device obtains a plurality of search results corresponding to a query request, wherein the plurality of search results comprise one or more search result classifications, each search result classification corresponds to one or more tags.

Specifically, when a user performs network browsing using a user equipment, he/she may interact with the user equipment through a keyboard, a touch screen, a voice input device, and the like, to input a query request regarding the user's desired query, thereby initiating a search. The user may access some search websites through browser software of the user equipment, e.g., Yahoo, Google, Baidu, and then enter a query request in a search bar of these search websites to initiate a search, or initiate the search through a local search bar embedded in the browser. Thereafter, the user equipment sends the query request, entered into the search bar, by the user, to the network device, the network device receives the query request entered by the user. Those skilled in the art should understand that the present invention is not limited to the above two search initiating manners, and any existing or future possibly emerging search initiating manners are applicable to the present invention, should fall within the protection scope of the present invention, and are incorporated here by reference. Herein, the query request may include one or more keywords that can be characters, words, or phrases. In a voice file retrieval, the query request may also be confusion classifications, phones, phone st ngs, and other units; the query request may also include correlative words between keywords.

Afterwards, the network device obtains one or more tags corresponding to the query request. Specifically, the network device extracts keyword(s) from the query request, and obtains one or more tags corresponding to the keyword(s) based on the extracted keyword. The one or more tags may be obtained by querying in a resource tag database according to the resource types, or obtained by performing cluster processing to the search result classifications. Preferably, the network device may determine a tag corresponding to the query request based on personal interest information in the user registration information, historical records information of a plurality of users, and/or scenario attributes of the user equipment. Herein, the scenario attributes of the user equipment include, but not limited to: time information of receiving the query request entered by the user, location information of the current location of the user equipment, weather information of the user equipment's current location, etc. Those skilled in the art would appreciate that the scenario attributes of the user equipment are only exemplary, and any other scenario attributes of the user equipment, if applicable to the present invention, should be included within the protection scope of this claim, and will be incorporated here by reference.

For example, the query request entered by the user is “public servant,” the network device obtains a plurality of tags including “hot course,” “online learning,” “low price,” “examination,” “application” corresponding to the query request “public servant” through obtaining personal interest information of the user and/or historical records information of a plurality of users, or further obtains corresponding tags including “examination,” “application” and the like corresponding to the query request “public servant” in conjunction with the time information when the network device receives the query request entered by the user being the eve of the public servant examination.

Preferably, the network device may obtain historical records information of a plurality of users on the network and information environment changes based on the personal interest information updated in the user registration information, and/or obtain more user data to analyze user interests and habits, thereby updating the tags corresponding to the key words.

Afterwards, the network device obtains one or more search result classifications corresponding to the one or more tags. Alternatively, the network device may perform search based on the query request and one or more tags to obtain search results matching the query request and one or more tags; then classify the search results based on the one or more tags to obtain one or more search result classifications corresponding to the one or more tags, respectively. For example, the query request entered by the user is “Gastroenteritis”; the obtained tags corresponding to the query request include: “treatment,” “etiology,” “symptom,” “diet & care,” etc.; then the network device performs search based on the query request “Gastroenteritis” in conjunction with tags “treatment,” “etiology,” “symptom,” “diet & care,” respectively, obtaining 4 search result classifications corresponding to tags “treatment,” “etiology,” “symptom,” “diet & care,” respectively. Or, search is performed based on the query request “Gastroenteritis” and the tags “treatment,” “etiology,” “symptom,” “diet & care,” obtaining search results matching the query request “Gastroenteritis” and the tags “treatment,” “etiology,” “symptom,” “diet & care”; then, the search results are classified based on the tags “treatment,” “etiology,” “symptom,” “diet & care,” obtaining 4 search result classifications corresponding to the tags “treatment,” “etiology,” “symptom,” “diet & care,” respectively. Optionally, the network information database does not necessarily have search results matching the query request entered by the user and the tags, then the network device may create information matching the query request and respective tags in the one or more tags based on the query request and the one or more tags, respectively; then obtain search result classifications corresponding to one or more tags, respectively, based on information matching the query request and respective tags in one or more tags, respectively. For example, the network information database does not have search results matching the query request “Gastroenteritis” and the tag “etiology”; then the network device may create page content matching “etiology of Gastroenteritis” through obtaining information regarding “etiology of Gastroenteritis” in the network or other offline resources; then obtains the search result classification corresponding to the tag “etiology” as one search result classification among a plurality of search result classifications for the query request “Gastroenteritis” and the tags “treatment,” “etiology,” “symptom,” “diet & care.”

At step S102, the network device determines the information of presentation pattern (“presentation pattern information”) corresponding to the search result classification based on the one or more tags corresponding to the search result classification.

Herein, the presentation pattern information includes, but not limited to, navigation information such as knowledge pattern, which knowledge pattern includes, but not limited to icons, pictures, texts, tags, etc. those skilled in the art should understand that the above presentation pattern information is only exemplary, and any existing or future possibly developed presentation pattern information, if applicable to the present invention, should be included within the protection scope of the present invention and is incorporated here by reference.

Hereinafter, it will be illustrated as to how to determine presentation pattern information corresponding to the search result classification based on one or more tags corresponding to the search result classification.

### Example 1

Based on historical records information of a plurality of users and/or time information when the query request entered by the user is received, determine tags associated with educational courses include hot, online learning, trial lesson, low price, etc.

The network device receives the query request “IELTS Course” entered by the user, then the query request belongs to an educational course; the network device, based on the query request, obtains one or more tags corresponding to the query request, “hot,” “online learning,” “trial lesson,” “low price.”

Afterwards, the network device obtains 4 search result classifications corresponding to the tags “hot,” “online learning,” “trial lesson,” “low price,” respectively, based on the query request “IELTS Course” and the tags “hot,” “online learning,” “trial lesson,” “low price.”

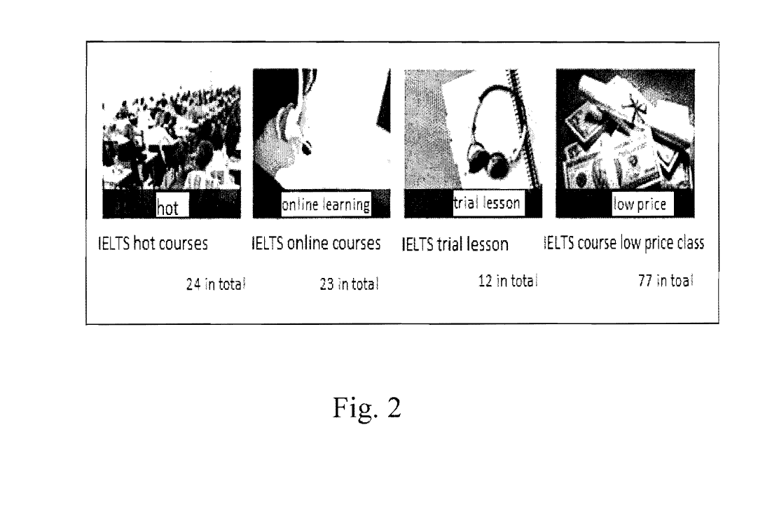

Based on the tags “hot,” “online learning,” “trial lesson,” “low price” corresponding to the 4 search result classifications, the network device determines the presentation pattern information corresponding to the 4 search result classifications, as shown in FIG. 2, each search result classification corresponds to a card-like identification in a form of picture, each picture correspondingly representing a search result classification. Preferably, the presentation area corresponding to the presentation pattern information may include a tag corresponding to the presentation pattern information, and the search result classification corresponding to the presentation pattern information includes a number of search results.

Preferably, the network device may determine presentation pattern information corresponding to the search result classification based on one or more tags corresponding to the search result classification in conjunction with the attributes of the user equipment. For example, the user equipment comprises a mobile terminal. Since the screen of a mobile terminal is relatively smaller than a fixed terminal, the network device may determine that the presentation pattern information corresponding to the search result classification is a smaller image or tag, so as to intuitively and conveniently present the search results, which is convenient for a user to select and promotes the user experience.

The network device provides at least one of the search result classifications to the corresponding user according to the corresponding presentation pattern information.

Specifically, the network device provides at least one search result classification to the corresponding user according to the presentation pattern information, wherein at least one of one or more tags corresponding to the search result classification is presented in a presentation area corresponding to the presentation pattern information.

Preferably, the network device may provide at least one search result classification to the corresponding user according to the presentation pattern information based on a priority of the tag. Specifically, the network device may provide the at least one search result classification to the corresponding user based on the priority of the tag in a manner in which the presentation pattern information corresponding to a higher priority search result classification precedes the presentation pattern information corresponding a lower priority search result classification, wherein the priority of the tag is determined based on user experience fed back from the user, user satisfactory degree, and user operation path, CRT, business benefits, time information of receiving the query sequence entered by the user, and the like. Those skilled in the art would appreciate that the above information for determining the priority of a tag is only exemplary, and if other information for determining the priority of a tag is applicable to the present invention, it should be included within the protection scope of the present invention and is incorporated here by reference.

Optionally, after the network device provides the at least one search result classification according to the presentation pattern information to the corresponding user, the user may perform an access operation on a presentation area corresponding to the presentation pattern information, and the network device provide, based on an access operation on a tag in a presentation area by the user, an access page corresponding to the access operation to the user, wherein the access page is generated based on one or more target search results corresponding to the tag in the search result classification. The access page includes a result page content matching the query request in the target search results. Continue example 1, for example, if the user performs an access operation on the tag “hot” in the presentation area, the network device provides, based on the user's access operation, the access page corresponding to the tag “hot” to the user, which access page includes a plurality of target search results matching the query request “IELTS” and the tag “hot.” Afterwards, the user may perform an access operation in the access page, to obtain content information corresponding to at least one target search result.

When a search result classification corresponds to a plurality of tags, then the network device determines a plurality of presentation pattern information corresponding to the search result classification based on a plurality of tags corresponding to the search result classification, then provides each search result classification, according to the plurality of presentation pattern information corresponding to the search result classification, to the corresponding user. For example, continue example 1, in which the query request entered by the user is “IELTS Course,” the search result classification A corresponds to two tags: “online learning,” “trial lesson”; the network device determines a plurality of presentation patterns corresponding to the search result classification A based on the 2 tags, e.g., the presentation pattern information of the tag “online learning” is in a picture form, while the presentation pattern information of the tag “trial lesson” is in a text form. The network device provides the two presentation pattern information corresponding to the search result classification A to the user. It may select one of them to the user, or dynamically provide the two presentation pattern information to the user in a dynamic change manner.

By classifying the search results according to tags and providing the search result classifications to the user according to the presentation pattern information corresponding to the corresponding pattern, the present invention helps the user to quickly find the desired information when the user's search demand is indefinite. Meanwhile, the present invention helps the user to clarify his/her demands and promotes the user's search experience. Particularly when the user uses a mobile terminal to perform information search, the present method provides intuitive search results to the user, which facilitates user operation and helps the user to quickly obtain the desired information.

FIG. 2 shows a schematic diagram of an apparatus for providing search results according to one embodiment of the present invention. As shown in FIG. 2, the apparatus comprises a search result obtaining module 301, a presentation pattern information determining module 302, and a presentation pattern information providing module 303.

Herein, the search result obtaining module 301 obtains a plurality of search results corresponding to a query request, wherein the plurality of search results comprise one or more search result classifications, each search result classification corresponds to one or more tags.

Specifically, the search result obtaining module comprises: a query request receiving module (not shown), a tag obtaining module (not shown), and a search result classification obtaining module (not shown).

Herein, when a user performs network browsing using a user equipment, he/she may interact with the user equipment through a keyboard, a touch screen, a voice input device, and the like, to input a query request regarding the user's desired query, thereby initiating a search. The user may access some search websites through browser software of the user equipment, e.g., Yahoo, Google, Baidu, and then enter a query request in a search bar of these search websites to initiate a search, or initiate the search through a local search bar embedded in the browser. Thereafter, the user equipment sends the query request, entered into the search bar by the user, to the query request receiving module, the query receiving module receives the query request entered by the user. Those skilled in the art should understand that the present invention is not limited to the above two search initiating manners, and any existing or future possibly emerging search initiating manners are applicable to the present invention, should fall within the protection scope of the present invention, and are incorporated here by reference. Herein, the query request may include one or more keywords that can be characters, words, or phrases. In a voice file retrieval, the query request may also be confusion classifications, phones, phone strings, and other units; the query request may also include correlative words between keywords.

Afterwards, the tag obtaining module obtains one or more tags corresponding to the query request. Specifically, the network device extracts keyword(s) from the query request, and obtains one or more tags corresponding to the keyword(s) based on the extracted keyword. The one or more tags may be obtained by querying in a resource tag database according to the resource types, or obtained by performing cluster processing to the search result classifications. Preferably, the tag obtaining module may comprise a tag determining sub-module (not shown in the figure). The tag determining submodule is configured to determine a tag corresponding to the query request based on personal interest information in the user registration information, historical records information of a plurality of users, and/or scenario attributes of the user equipment. Herein, the scenario attributes of the user equipment include, but not limited to: time information of receiving the query request entered by the user, location information of the current location of the user equipment, weather information of the user equipment's current location, etc. Those skilled in the art would appreciate that the scenario attributes of the user equipment are only exemplary, and any other scenario attributes of the user equipment, if applicable to the present invention, should be included within the protection scope of this claim, and will be incorporated here by reference.

For example, the query request entered by the user is “public servant,” the tag determining submodule obtains a plurality of tags including “hot course,” “online learning,” “low price,” “examination,” “application” corresponding to the query request “public servant” through obtaining personal interest information of the user and/or historical records information of a plurality of users, or further obtains corresponding tags including “examination,” “application” and the like corresponding to the query request “public servant” in conjunction with the time information when the network device receives the query request entered by the user being the eve of the public servant examination.

Preferably, the network device may obtain historical records information of a plurality of users on the network and information environment changes based on the personal interest information updated in the user registration information, and/or obtain more user data to analyze user interests and habits, thereby updating the tags corresponding to the key words.

Afterwards, the search result classification obtaining module obtains one or more search result classifications corresponding to the one or more tags. Alternatively, the search result classification obtaining module may comprise: a first search result obtaining submodule configured to perform search based on the query request and one or more tags to obtain search results matching the query request and one or more tags; a first search result classification obtaining submodule configured to classify the search results based on the one or more tags to obtain one or more search result classifications corresponding to the one or more tags, respectively. For example, the query request entered by the user is “Gastroenteritis”; the obtained tags corresponding to the query request include: “treatment,” “etiology,” “symptom,” “diet & care,” etc.; then the search result classification obtaining module performs search based on the query request “Gastroenteritis” in conjunction with tags “treatment,” “etiology,” “symptom,” “diet & care,” respectively, obtaining 4 search result classifications corresponding to tags “treatment,” “etiology,” “symptom,” “diet & care,” respectively. Or, search is performed based on the query request “Gastroenteritis” and the tags “treatment,” “etiology,” “symptom,” “diet & care,” obtaining search results matching the query request “Gastroenteritis” and the tags “treatment,” “etiology,” “symptom,” “diet & care”; then, the search results are classified based on the tags “treatment,” “etiology,” “symptom,” “diet & care,” obtaining 4 search result classifications corresponding to the tags “treatment,” “etiology,” “symptom,” “diet & care,” respectively. Optionally, the network information database does not necessarily have search results matching the query request entered by the user and the tags, then the search result classification obtaining module may comprise: a second information creating submodule for creating information matching the query request and respective tags in the one or more tags based on the query request and the one or more tags, respectively; a second search result classification obtaining submodule configured to obtain search result classifications corresponding to one or more tags, respectively, based on information matching the query request and respective tags in one or more tags, respectively. For example, the network information database does not have search results matching the query request “Gastroenteritis” and the tag “etiology”; then the second information creating submodule may create page content matching “etiology of Gastroenteritis” through obtaining information regarding “etiology of Gastroenteritis” in the network or other offline resources; and next, the second search result classification obtaining submodule obtains the search result classification corresponding to the tag “etiology” as one search result classification among a plurality of search result classifications for the query request “Gastroenteritis” and the tags “treatment,” “etiology,” “symptom,” “diet & care.”

The presentation pattern information determining module 302 determines presentation pattern information corresponding to the search result classification based on the one or more tags corresponding to the search result classification.

Herein, the presentation pattern information includes, but not limited to, navigation information such as knowledge pattern, which knowledge pattern includes, but not limited to icons, pictures, texts, tags, etc. those skilled in the art should understand that the above presentation pattern information is only exemplary, and any existing or future possibly developed presentation pattern information, if applicable to the present invention, should be included within the protection scope of the present invention and is incorporated here by reference.

Hereinafter, it will be illustrated as to how the presentation pattern information determining module 302 determines presentation pattern information corresponding to the search result classification based on one or more tags corresponding to the search result classification.

### Example 2

Based on historical records information of a plurality of users and/or time information when the query request entered by the user is received, determine tags associated with educational courses include hot, online learning, trial lesson, low price, etc.

The query request receiving module receives the query request “IELTS Course” entered by the user, then the query request belongs to an educational course; the tag obtaining module, based on the query request, obtains one or more tags corresponding to the query request, “hot,” “online learning,” “trial lesson,” “low price.”

Afterwards, the search result classification obtaining module obtains 4 search result classifications corresponding to the tags “hot,” “online learning,” “trial lesson,” “low price,” respectively, based on the query request “IELTS Course” and the tags “hot,” “online learning,” “trial lesson,” “low price.”

Based on the tags “hot,” “online learning,” “trial lesson,” “low price” corresponding to the 4 search result classifications, the presentation pattern information determining module 302 determines the presentation pattern information corresponding to the 4 search result classifications, as shown in FIG. 2, each search result classification corresponds to a card-like identification in a form of picture, each picture correspondingly representing a search result classification. Preferably, the presentation area corresponding to the presentation pattern information may include a tag corresponding to the presentation pattern information, and the search result classification corresponding to the presentation pattern information includes a number of search results.

Preferably, the presentation pattern information determining module 302 may determine presentation pattern information corresponding to the search result classification based on one or more tags corresponding to the search result classification in conjunction with the attributes of the user equipment. For example, the user equipment comprises a mobile terminal. Since the screen of a mobile terminal is relatively smaller than a fixed terminal, the presentation pattern information determining module 302 may determine that the presentation pattern information corresponding to the search result classification is a smaller image or tag, so as to intuitively and conveniently present the search results, which is convenient for a user to select and promotes the user experience.

The presentation pattern information providing module 303 provides at least one of the search result classifications to the corresponding user according to the corresponding presentation pattern information.

Specifically, the presentation pattern information providing module 303 may comprise: a first presentation pattern information providing module configured to provide at least one search result classification to the corresponding user according to the presentation pattern information, wherein at least one of one or more tags corresponding to the search result classification is presented in a presentation area corresponding to the presentation pattern information.

Preferably, the presentation pattern information providing module 303 may comprise: a second presentation pattern information providing module configured to provide at least one search result classification to the corresponding user according to the presentation pattern information based on a priority of the tag. Specifically, the second presentation pattern information providing module may provide the at least one search result classification to the corresponding user based on the priority of the tag in a manner in which the presentation pattern information corresponding to a higher priority search result classification precedes the presentation pattern information corresponding a lower priority search result classification, wherein the priority of the tag is determined based on user experience fed back from the user, user satisfactory degree, and user operation path, CRT, business benefits, time information of receiving the query sequence entered by the user, and the like. Those skilled in the art would appreciate that the above information for determining the priority of a tag is only exemplary, and if other information for determining the priority of a tag is applicable to the present invention, it should be included within the protection scope of the present invention and is incorporated here by reference.

Optionally, after the presentation pattern information providing module 303 provides the at least one search result classification accord ng to the presentation pattern information to the corresponding user, the user may perform an access operation on a presentation area corresponding to the presentation pattern information, and the apparatus for providing search results according to one embodiment of the present invention may further comprise: an access page providing module configured to provide, based on an access operation on a tag in a presentation area by the user, an access page corresponding to the access operation to the user, wherein the access page is generated based on one or more target search results corresponding to the tag in the search result classification. The access page includes a result page content match ng the query request in the target search results. Continue example 2, for example, if the user performs an access operation on the tag “hot” in the presentation area, the access page providing module provides, based on the user's access operation, the access page corresponding to the tag “hot” to the user, which access page includes a plurality of target search results matching the query request “IELTS” and the tag “hot.” Afterwards, the user may perform an access operation in the access page, to obtain content information corresponding to at least one target search result.

When a search result classification corresponds to a plurality of tags, then the presentation pattern information determining module comprises: a first presentation pattern information determining module (not shown) configured to determine a plurality of presentation pattern information corresponding to the search result classification based on a plurality of tags corresponding to the search result classification. Afterwards, a third presentation pattern information providing module (not shown) is configured to provide each search result classification, according to the plurality of presentation pattern information corresponding to the search result classification, to the corresponding user. For example, continue example 2, in which the query request entered by the user is “IELTS Course,” the search result classification A corresponds to 2 tags: “online learning,” “trial lesson”; the first presentation pattern information determining module determines a plurality of presentation patterns corresponding to the search result classification A based on the 2 tags, e.g., the presentation pattern information of the tag “online learning” is in a picture form, while the presentation pattern information of the tag “trial lesson” is in a text form. The third presentation pattern information providing module provides the 2 presentation pattern information corresponding to the search result classification A to the user. It may select one of them to the user, or dynamically provide the 2 presentation pattern information to the user in a dynamic change manner.

By classifying the search results according to tags and providing the search result classifications to the user according to the presentation pattern information corresponding to the corresponding pattern, the present invention helps the user to quickly find the desired information when the user's search demand is indefinite. Meanwhile, the present invention helps the user to clarify his/her demands and promotes the user's search experience. Particularly when the user uses a mobile terminal to perform information search, the present method provides intuitive search results to the user, which facilitates user operation and helps the user to quickly obtain the desired information.

It should be noted that the present invention may be implemented in software and/or a combination of software and hardware. For example, each module of the present invention may be implemented by an application-specific integrated circuit (ASIC) or any other similar hardware device. In one embodiment, the software program of the present invention may be executed through a processor to implement the steps or functions as mentioned above. Likewise, the software program (including relevant data structure) of the present invention may be stored in a computer readable recording medium, e.g., RAM memory, magnetic or optic driver or soft floppy or similar devices. Additionally, some steps or functions of the present invention may be implemented by hardware, for example, a circuit cooperating with the processor so as to implement various steps of functions.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. No reference signs in the claims should be regarded as limiting the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

1. A method for providing search results, comprising
obtaining a plurality of search results corresponding to a query request, wherein the plurality of search results comprise one or more search result classifications, each search result classification corresponds to one or more tags;
determining presentation pattern information corresponding to the search result classification based on the one or more tags corresponding to the search result classification;
providing at least one of the search result classifications to the corresponding user according to the corresponding presentation pattern information.

2. The method according to claim 1, wherein the providing at least one of the search result classifications to the corresponding user according to the corresponding presentation pattern information comprises:
providing module configured to provide at least one search result classification to the corresponding user according to the presentation pattern information, wherein at least one of one or more tags corresponding to the search result classification is presented in a presentation area corresponding to the presentation pattern information.

3. The method according to claim 2, wherein the method further comprises:
providing, based on an access operation on a tag in a presentation area by the user, an access page corresponding to the access operation to the user, wherein the access page is generated based on one or more target search results corresponding to the tag in the search result classification.

4. The method according to claim 1, wherein the obtaining a plurality of search results corresponding to a query request comprises:
receiving a query request entered by a user;
obtaining, based on the query request, one or more tags corresponding to the query request;
obtaining, based on the query request and one or more tags, one or more search result classifications corresponding to the one or more tags, respectively.

5. The method according to claim 4, wherein the obtaining, based on the query request and one or more tags, one or more search result classifications corresponding to the one or more tags, respectively, comprises:
performing search based on the query request and one or more tags to obtain search results matching the query request and one or more tags;
classifying the search results based on the one or more tags to obtain one or more search result classifications corresponding to the one or more tags, respectively.

6. The method according to claim 4, wherein the obtaining, based on the query request and one or more tags, one or more search result classifications corresponding to the one or more tags, respectively, comprises:
creating information matching the query request and respective tags in the one or more tags based on the query request and the one or more tags, respectively;
obtaining search result classifications corresponding to one or more tags, respectively, based on the information matching the query request and respective tags in one or more tags, respectively.

7. The method according to claim 4, wherein the obtaining, based on the query request, one or more tags corresponding to the query request comprises:
determining a tag corresponding to the query request based on the historical records information of a plurality of users, and/or the time information when the query request entered by the user is received.

8. The method according to claim 1, wherein the search result cla ca ion corresponds to a plurality of tags;
where n the determining presentation pattern information corresponding to the search result classification based on the one or more tags corresponding to the search result classification comprises:
determining a plurality of presentation pattern information corresponding to the search result classification based on a plurality of tags corresponding to the search result classification;
wherein the providing at least one of the search result classifications to the corresponding user according to the corresponding presentation pattern information comprises:
providing each search result classification according to the plurality of presentation pattern information corresponding to the search result classification to the corresponding user.

9. An apparatus for providing search results, comprising
a search result obtaining module configured to obtain a plurality of search results corresponding to a query request, wherein the plurality of search results comprise one or more search result classifications, each search result classification corresponds to one or more tags;
a presentation pattern information determining module configured to determine presentation pattern information corresponding to the search result classification based on the one or more tags corresponding to the search result classification;
a presentation pattern information providing module configured to provide at least one of the search result classifications to the corresponding user according to the corresponding presentation pattern information.

10. The apparatus according to claim 9, wherein the presentation pattern information providing module comprises:
a first presentation pattern information providing module configured to provide at least one search result classification to the corresponding user according to the presentation pattern information, wherein at least one of one or more tags corresponding to the search result classification is presented in a presentation area corresponding to the presentation pattern information.

11. The apparatus according to claim 10, wherein the apparatus further comprises:
an access page providing module configured to provide, based on an access operation on a tag in a presentation area by the user, an access page corresponding to the access operation to the user, wherein the access page is generated based on one or more target search results corresponding to the tag in the search result classification.

12. The apparatus according to claim 9, wherein the search result obtaining module comprises:
a query request receiving module configured to receive a query request entered by a user;
a tag obtaining module configured to obtain, based on the query request, one or more tags corresponding to the query request;
a search result classification obtaining module configured to obtain, based on the query request and one or more tags, one or more search result classifications corresponding to the one or more tags, respectively.

13. The apparatus according to claim 12, wherein the search result classification obtaining module comprises:
a first search result obtaining submodule configured to perform search based on the query request and one or more tags to obtain search results matching the query request and one or more tags;
a first search result classification obtaining submodule configured to classify the search results based on the one or more tags to obtain one or more search result classifications corresponding to the one or more tags, respectively.

14. The apparatus according to claim 12, wherein the search result classification obtaining module comprises:
a second information creating submodule for creating information matching the query request and respective tags in the one or more tags based on the query request and the one or more tags, respectively;
a second search result classification obtaining submodule configured to obtain search result classifications corresponding to one or more tags, respectively, based on the information matching the query request and respective tags in one or more tags, respectively.

15. The apparatus according to claim 12, wherein the tag obtaining module comprises:
a tag determining submodule configured to determine a tag corresponding to the query request based on the historical records information of a plurality of users, and/or the time information when the query request entered by the user is received.

16. The apparatus according to claim 9, wherein the search result classification corresponds to a plurality of tags;
wherein the presentation pattern information determining module comprises:
a first presentation pattern information determining module configured to determine a plurality of presentation pattern information corresponding to the search result classification based on a plurality of tags corresponding to the search result classification;
wherein the pattern presentation information providing module comprises:
a third presentation pattern information providing module configured to provide each search result classification according to the plurality of presentation pattern information corresponding to the search result classification to the corresponding user.

17. A computer readable recording media, which comprises computer codes, when the computer codes are executed, the method of claim 1 is performed.

18. A computer software product, when the computer software product is executed by a computer device, the method of claim 1 is performed.

19. A computer device, which comprises a storage and a processor, the storage stores computer codes, and the processor is configured to execute the computer codes so as to perform the method of claim 1 is performed.
